(19) United States
(12) Patent Application Publication
(10) Pub. No.: US 2025/0008455 A1
(43) Pub. Date: Jan. 2, 2025

(54) FIRST WIRELESS COMMUNICATION DEVICE AND SECOND WIRELESS COMMUNICATION DEVICE

(71) Applicant: FUJITSU LIMITED, Kawasaki-shi Kanagawa (JP)

(72) Inventors: Yoshiaki OHTA, Yokohama (JP); Takako HORI, Sagamihara (JP)

(73) Assignee: FUJITSU LIMITED, Kawasaki-shi Kanagawa (JP)

(21) Appl. No.: 18/795,313

(22) Filed: Aug. 6, 2024

Related U.S. Application Data
(63) Continuation of application No. PCT/JP2022/005768, filed on Feb. 14, 2022.

(51) Int. Cl. H04W 56/00; H04W 24/10

(52) U.S. Cl. CPC H04W 56/001; H04W 24/10

(57) ABSTRACT

A first wireless communication device in a wireless communication system, includes: a first memory; and processor circuitry coupled to the memory, the processor circuitry being configured to control communication with a second wireless communication device that has a survival time, being capable of controlling wireless measurement performed by the second wireless communication device in a survival time duration by using information related to performance of wireless measurement included in a control signal, and being capable of receiving data transmitted under priority control performed between the data and other data in the second wireless communication device.

### CROSS-REFERENCE TO RELATED APPLICATION

This application is a continuation application of International Application PCT/JP2022/005768 filed on Feb. 14, 2022 and designated the U.S., the entire contents of which are incorporated herein by reference.

### FIELD

The present disclosure relates to a first wireless communication device and a second wireless communication device.

### BACKGROUND

In recent years, wireless communication systems using a wireless telegraphy have been used. The wireless communication systems are also used in facilities such as factories, for example.

In factories, for example, manufacturing equipment and apparatuses are wirelessly connected to a control monitoring system, and data and control signals are transmitted and received by using the IoT (Internet of Things). The IoT used in factories may also be referred to specifically as the IIoT (Industrial IoT).

If missing reception or the like of a control signal occurs in a factory, a serious error may occur, such as stagnation or interruption of a production line of the factory, and therefore, the IIoT may be desired to accommodate severer delay or error conditions than the normal IoT. Thus, in the IIoT, provided that predetermined conditions are met, a communication device transitions to a state (hereinafter also referred to as “survival time state (STS)”) in which the communication device needs to ensure that data arrives within a packet arrival time limit (hereinafter also referred to as “survival time”) acceptable to the system, to thereby improve the probability of data arrival.

IIoT-related technologies are described in the following related art documents.

3GPP TS36.133 LTE-A Radio Measurement Specification, 3GPP TS36.300 LTE-A General Specification, 3GPP TS36.211 LTE-A PHY Channel Specification, 3GPP TS36.212 LTE-A PHY Coding Specification, 3GPP TS36.213 LTE-A PHY Procedure Specification, 3GPP TS36.214 LTE-A PHY Measurement Specification, 3GPP TS36.321 LTE-A MAC Specification, 3GPP TS36.322 LTE-A RLC Specification, 3GPP TS36.323 LTE-A PDCP Specification, 3GPP TS36.331 LTE-A RRC Specification, 3GPP TS36.413 LTE-A S1 Specification, 3GPP TS36.423 LTE-A X2 Specification, 3GPP TS36.425 LTE-A Xn Specification, 3GPP TR36.912 NR Radio Access Overview, 3GPP TR38.913 NR Requirements, 3GPP TR38.913 NR Requirements, 3GPP TR38.801 NR Network Architecture Overview, 3GPP TR38.802 NR PHY Overview, 3GPP TR38.803 NR RF Overview, 3GPP TR38.804 NR L2 Overview, 3GPP TR38.900 NR High Frequency Overview, 3GPP TS38.300 NR General Specification, 3GPP TS37.340 NR Multi-Connectivity General Specification, 3GPP TS38.201 NR PHY Specification General Specification, 3GPP TS38.202 NR PHY Service General Specification, 3GPP TS38.211 NR PHY Channel Specification, 3GPP TS38.212 NR PHY Coding Specification, 3GPP TS38.213 NR PHY Data Channel Procedure Specification, 3GPP TS38.214 NR PHY Control Channel Procedure Specification, 3GPP TS38.215 NR PHY Measurement Specification, 3GPP TS38.321 NR MAC Specification, 3GPP TS38.322 NR RLC Specification, 3GPP TS38.323 NR PDCP Specification, 3GPP TS37.324 NR SDAP Specification, 3GPP TS38.331 NR RRC Specification, 3GPP TS38.401 NR Architecture General Specification, 3GPP TS38.410 NR Core Network General Specification, 3GPP TS38.413 NR Core Network AP Specification, 3GPP TS38.420 NR Xn Interface General Specification, 3GPP TS38.423 NR XnAP Specification, 3GPP TS38.470 NR F1 Interface General Specification, 3GPP TS38.473 NR F1AP Specification, and 3GPP TSG RAN meeting #92e Electronic Meeting, Jun. 14-18, 2021 RP-211566 are disclosed as related art.

### SUMMARY

According to an aspect of the embodiments, a first wireless communication device in a wireless communication system, includes: a memory; and a processor coupled to the memory, the processor being configured to control communication with a second wireless communication device that has a survival time, being capable of controlling wireless measurement performed by the second wireless communication device in a survival time duration by using information related to performance of wireless measurement included in a control signal, and being capable of receiving data transmitted under priority control performed between the data and other data in the second wireless communication device.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram illustrating a configuration example of a wireless communication system 3;

FIG. 2 is a diagram illustrating a configuration example of a wireless communication system 10;

FIG. 3 is a diagram representing a configuration example of a base station device 200;

FIG. 4 is a diagram representing a configuration example of a terminal device 100;

FIG. 5 is a diagram illustrating an example of measurement gap (MG) performance in a survival time state;

FIG. 6 is a diagram illustrating an example of GapConfig composing MeasGapConfig;

FIG. 7 is a diagram illustrating an example of MG control;

FIG. 8 is a diagram illustrating an example of the MG control;

FIG. 9 is a diagram illustrating an example of the MG control;

FIG. 10 is a diagram illustrating an example of generation of new data in the survival time state;

FIG. 11 is a diagram illustrating an example of Logical Channel Prioritization after a change;

FIG. 12 is a diagram illustrating an example of an uplink (UL) radio resource control (RRC) message;

FIG. 13 is a diagram illustrating an example of the UL RRC message; and

FIG. 14 is a diagram illustrating an example of Layer 2 architecture.

### DESCRIPTION OF EMBODIMENTS

The communication device may configure a measurement duration of a wireless duration (for example, measurement gap (MG)) in the survival time state, and perform wireless measurement. The MG indicates measurement of, in addition to reception quality from a cell currently in communication, wireless signal reception quality of a band having the same serving frequency but different from a current band or wireless signal reception quality from another frequency band other than the serving frequency or from a different radio access technology (RAT), or indicates a measurement period or control. In a case where a wireless communication circuit used for the MG and a wireless communication circuit used for communication are the same, the communication device may not transmit and receive data to and from a base station device 200 currently in communication during the MG.

However, handling of the MG in the survival time state is at a stage where discussion have been made currently, and has not been determined.

Therefore, one disclosure provides a first wireless communication device and a second wireless communication device that prevent data transmission by MG performance from being disabled in a survival time state of IIoT.

### First Embodiment

A first embodiment will be described.

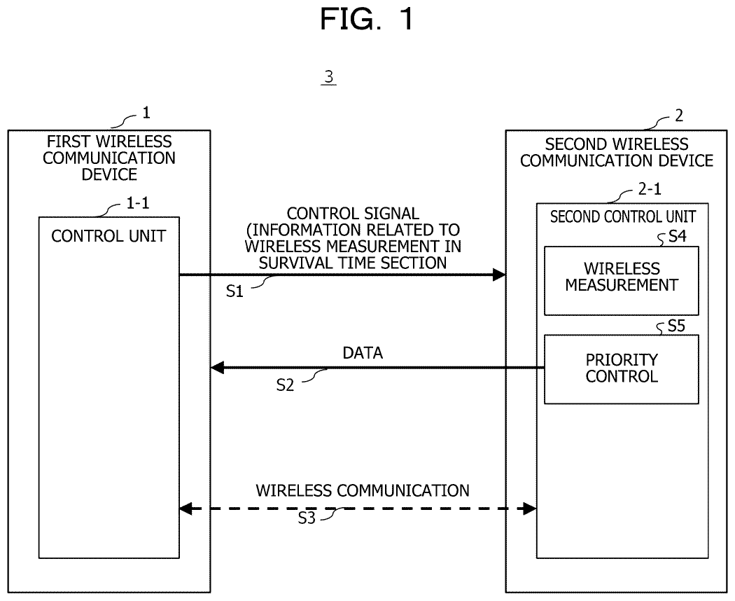

FIG. 1 is a diagram illustrating a configuration example of a wireless communication system 3. The wireless communication system 3 includes a first wireless communication device 1 and a second wireless communication device 2. The first wireless communication device and the second wireless communication device perform wireless communication (S3).

The first wireless communication device 1 is a communication device that performs wireless communication. The first wireless communication device 1 includes a control unit 1-1. The control unit 1-1 is composed of, for example, a processor included in the first wireless communication device 1 executing a program stored in the first wireless communication device 1.

The control unit 1-1 controls wireless measurement performed by the second wireless communication device 2. The control unit 1-1 controls the wireless measurement of the second wireless communication device by, for example, including information related to the wireless measurement in a period of a survival time state (survival time duration) in a control signal and transmitting the control signal (S1).

Furthermore, the control unit 1-1 receives data transmitted under priority control of the second wireless communication device 2 (S2).

The second wireless communication device 2 is a communication device that performs wireless communication corresponding to a survival time. The second wireless communication device 2 includes a second control unit 2-1. The second control unit 2-1 is composed of, for example, a processor included in the second wireless communication device 2 executing a program stored in the second wireless communication device 2.

The second control unit 2-1 performs wireless measurement S4 according to information related to the wireless measurement included in a control signal. For example, the second control unit 2-1 performs control such as lowering priority (canceling performance) of the wireless measurement S4, and increases priority of data transmission. Furthermore, for example, the second control unit 2-1 may shift a performance timing of the wireless measurement S4 to a later time (rear part of a time axis). Note that, in the present specification, meaning of cancellation is treated as synonymous with lowering priority of performance.

Furthermore, when data other than data to be retransmitted is generated in the survival time, the second control unit 2-1 performs priority control S5 to determine which data is data to be preferentially transmitted, determines a data transmission order (transmission availability), and transmits the data (S2).

### Second Embodiment

A second embodiment will be described.

### <Wireless Communication System 10>

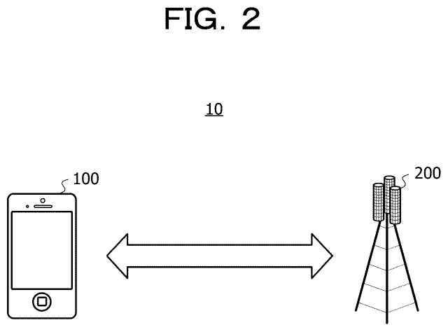

FIG. 2 is a diagram illustrating a configuration example of a wireless communication system 10. The wireless communication system 10 includes a base station device 200 and a terminal device 100. The wireless communication system 10 is, for example, a wireless communication system installed in a system. The wireless communication system 10 is, for example, a wireless communication system with IIoT capability.

The terminal device 100 is a communication device attached to a piece of equipment (apparatus) in the system. The base station device 200 is a communication device installed in the system.

The base station device 200 supports, for example, various communication generations (for example, 5G, Beyond 5G, and the like). The base station device 200 may be composed of a single unit or multiple units such as a CU (Central Unit) and a DU (Distributed Unit).

In the wireless communication system 10, the base station device 200 and the terminal device 100 communicate using the IIoT. In addition, it is assumed that the terminal device 100 and the base station device 200 support survival time.

### <Configuration Example of Base Station Device 200>

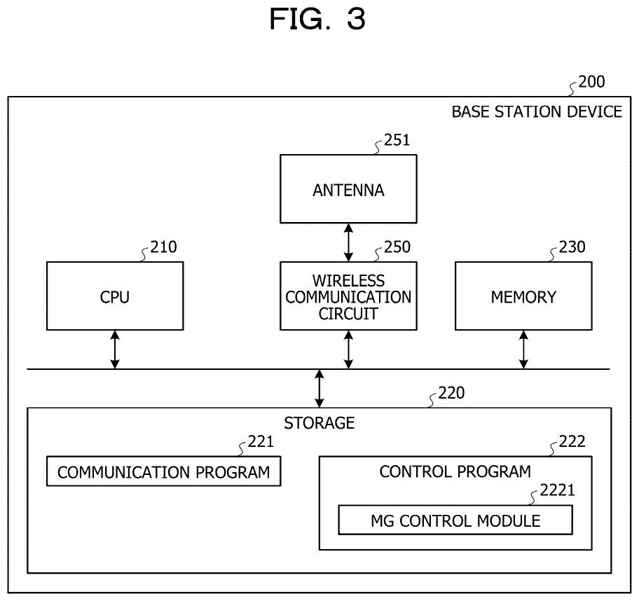

FIG. 3 is a diagram representing a configuration example of the base station device 200. The base station device 200 includes a central processing unit (CPU) 210, a storage 220, a memory 230, a wireless communication circuit 250, and an antenna 251.

The storage 220 is an auxiliary storage device that stores programs and data, such as a flash memory, a hard disk drive (HDD), or a solid state drive (SSD). The storage 220 stores a communication program 221 and a control program 222.

The memory 230 is an area in which the program stored in the storage 220 is loaded. Furthermore, the memory 230 may also be used as an area in which the program stores data.

The wireless communication circuit 250 is a device that performs wireless communication with the terminal device 100. The wireless communication circuit 250 includes the antenna 251. The antenna 251 includes, for example, a directional antenna capable of controlling a direction of transmission and reception of radio waves.

The CPU 210 is a processor that loads programs stored in the storage 220 into the memory 230, executes the loaded programs, composes various units, and realizes various types of processing.

The CPU 210 composes a communication unit and performs communication processing, by executing the communication program 221. The communication processing is processing of performing wireless communication with the terminal device 100. In the communication processing, the base station device 200 connects wirelessly to the terminal device 100, transmits data and control signals to the terminal device 100, and receives data from the terminal device 100.

The CPU 210 composes a control unit and performs control processing, by executing the control program 222. The control processing is processing of controlling wireless communication with the terminal device 100. In the control processing, the base station device 200 performs performance control (presence or absence of performance, instruction of a performance timing, and the like) of a measurement gap (MG) performed by the terminal device 100. Furthermore, the base station device 200 performs priority control (priority order of transmission, control of transmission availability, and the like) when data other than retransmission data is generated in the terminal device 100 in a survival time state, or receives data transmitted under the priority control.

By executing an MG control module 2221 of the control program 222, the CPU 210 composes the control unit to perform MG control processing. The MG control processing is processing of controlling presence or absence of execution of the MG, and the like in the terminal device 100. In the MG control processing, for example, the base station device 200 does not perform the MG in the survival time state. Furthermore, in the MG control processing, for example, the base station device 200 may (has capability to) shift the MG behind in terms of time (to a rear part of a time axis) in the survival time state.

### <Configuration Example of Terminal Device 100>

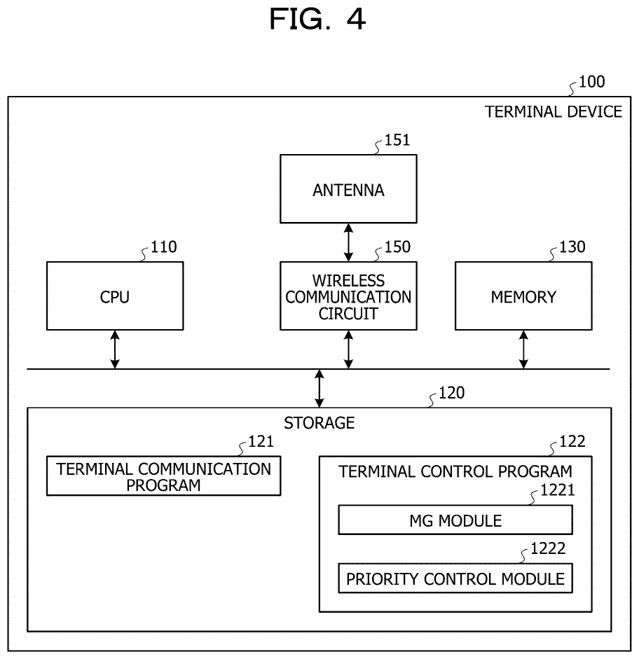

FIG. 4 is a diagram representing a configuration example of the terminal device 100. The terminal device 100 includes a CPU 110, a storage 120, a memory 130, a wireless communication circuit 150, and an antenna 151.

The storage 120 is an auxiliary storage device that stores programs and data, such as a flash memory, an HDD, or an SSD. The storage 120 stores a terminal communication program 121 and a terminal control program 122.

The memory 130 is an area into which the program stored in the storage 120 is loaded. Furthermore, the memory 130 may also be used as an area in which the program stores data.

The wireless communication circuit 150 is a device that performs wireless communication with the base station device 200. The wireless communication circuit 150 includes the antenna 151. The antenna 151 includes, for example, a directional antenna capable of controlling a direction of transmission and reception of radio waves.

The CPU 110 is a processor that loads programs stored in the storage 120 into the memory 130, executes the loaded programs, composes various units, and realizes various types of processing.

The CPU 110 composes a second communication unit and performs terminal communication processing, by executing the terminal communication program 121. The terminal communication processing is processing of performing wireless communication with the base station device 200.

By executing the terminal control program 122, the CPU 110 composes the second control unit to perform terminal control processing. The terminal control processing is, for example, processing in which communication is controlled by the base station device 200.

By executing an MG module 1221 included in the terminal control program 122, the CPU 110 composes the second control unit to perform MG processing. The MG processing is processing of executing (or not executing) the MG according to an instruction from the base station device 200. For example, in the MG processing, the terminal device 100 does not execute (or postpones or pends) the MG according to an instruction from the base station device 200 during the survival time state. Furthermore, for example, in the MG processing, the terminal device 100 executes the MG (shifts an execution time of the MG) after a predetermined time according to an instruction from the base station device 200 during the survival time state.

By executing a priority control module 1222 included in the terminal control program 122, the CPU 110 composes the second control unit to perform priority control processing. The priority control processing is processing of determining, when new data other than retransmission data is generated in the terminal device 100, a priority order of the retransmission data and the new data. For example, in a case where the new data has a large influence on the system, the terminal device 100 preferentially transmits the new data.

### <Survival Time State>

When the terminal device 100 recognizes that data transmission has failed N times (N is an integer of 1 or greater), the terminal device 100 transitions to the survival time state. The survival time state (STS) is a state where data transmission is boosted. The boosting of the data transmission is processing for improving a success probability of retransmission of the data that has failed to be transmitted, and for example, an increase in the number of times of retransmission, an increase in wireless resources for retransmission, and the like are executed. The terminal device 100 recognizes that the transmission has failed upon, for example, receiving non acknowledgement (NACK). Although the term “NACK” is used here for convenience, the NACK is more specifically a control signal in the physical layer (L1). In the case of 5G, the NACK corresponds to an UL grant that prompts retransmission. However, the NACK is not limited to this. The NACK may be any control signal for transition to the survival mode.

The survival time state ends, for example, in a predetermined time. Furthermore, the survival time state may end according to the number of times of transmission or the number of times of success of data transmission. Moreover, the survival time state may end as a wireless state becomes better than a predetermined level. Alternatively, the survival time may be ended by a control signal from a base station. The control signal is, for example, a signal for controlling the number of legs of packet data convergence protocol (PDCP) duplication and states of activation and deactivation.

### <Control of MG in Survival Time State>

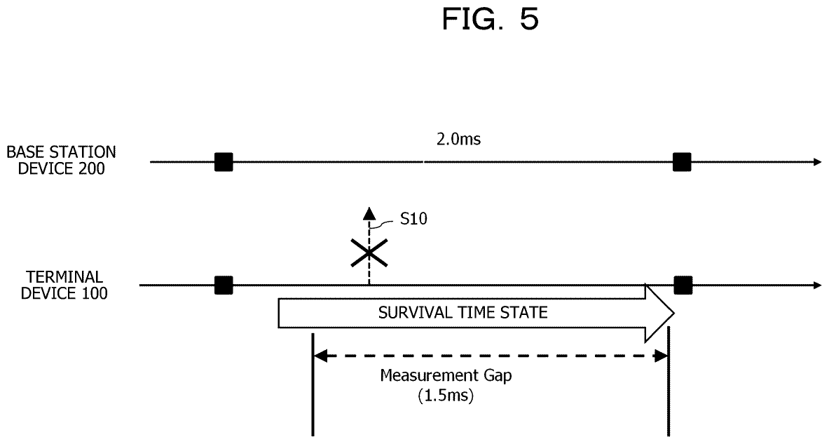

FIG. 5 is a diagram illustrating an example of MG performance in the survival time state. In FIG. 5, a black square indicates a starting point of a transmission cycle. The transmission cycle is, for example, 2.0 ms, and an MG period (period in which the MG is performed) is 1.5 ms. Note that the transmission cycle is assumed to have the same value as the survival time, for example.

As illustrated in FIG. 5, the terminal device 100 may perform the MG in the survival time state. Since the terminal device 100 performs wireless measurement in the MG performance, data may not be transmitted to the base station device 200 in communication (S10).

Therefore, the terminal device 100 controls performance of the MG in the survival time state. For example, the terminal device 100 controls whether or not to perform the MG in the survival time state or whether or not to perform (shift) the MG at another timing.

The control of the MG is configured to, for example, MeasGapConfig. For example, in a case where the MG is canceled without performing the shift, shiftMeas-r17 is configured to false (for example, 0). Furthermore, in a case where the shift is performed, shiftMeas-r17 is configured to true (for example, 1). The MeasGapConfig is configured by, for example, the base station device 200. The terminal device 100 cancels or shifts the MG according to the configuration.

Note that, in a case where the MG is not performed, for example, a radio frequency (RF) system for Inter-BWP/Inter-F/Inter-RAT is separately prepared.

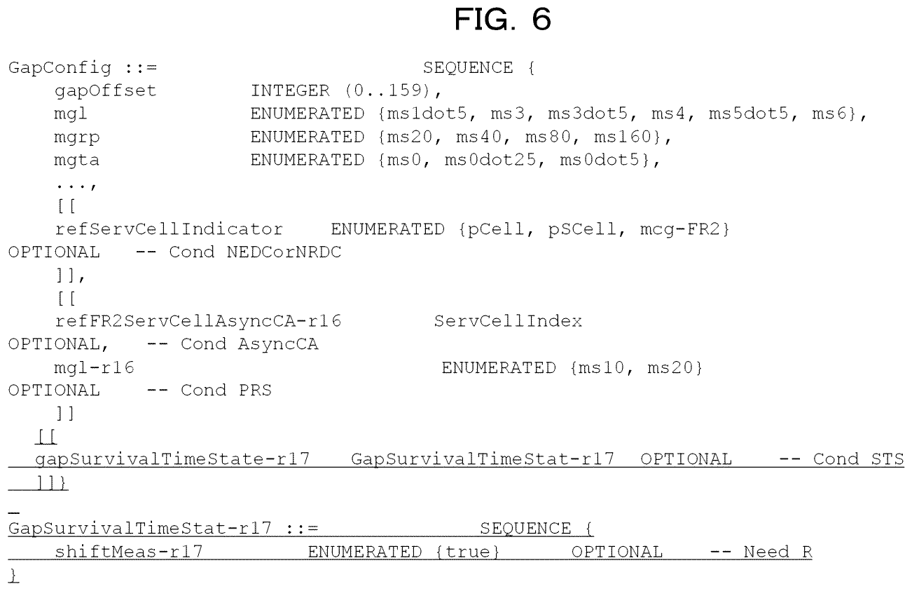

FIG. 6 is a diagram illustrating an example of GapConfig composing the MeasGapConfig. In FIG. 6, an underlined portion indicates an example of an additional element.

To the GapConfig, for example, an information element “gapSurvivalTimeState-r17” is added, and information related to control of the MG in a survival time mode is configured. Note that an information element name, a configuration value, and a condition are examples, and the present embodiment is not limited to these.

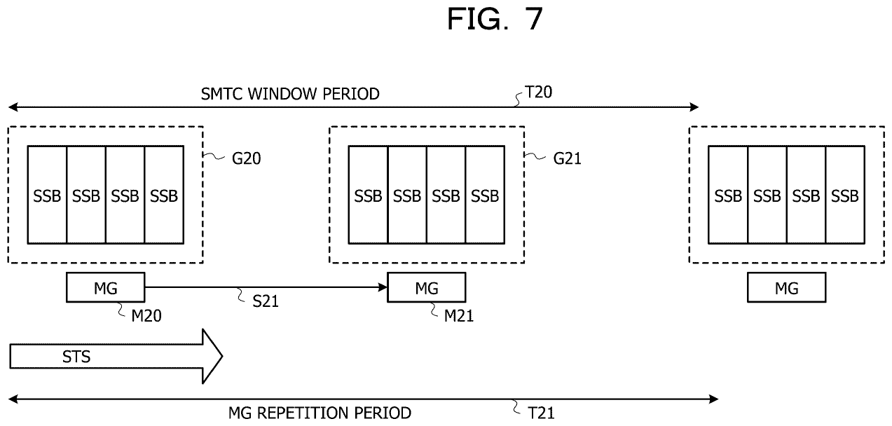

FIG. 7 is a diagram illustrating an example of the MG control. Since the MG is processing of measuring a neighbor cell, a synchronization signal block (SSB) of the cell is measured. A measurement period using the SSB is referred to as, for example, an SSB-based measurement timing configuration (SMTC) window period. In FIG. 7, a period T20 indicates the SMTC window period. Furthermore, in FIG. 7, a period T21 indicates an MG performance cycle (MG cycle). Furthermore, an SSB transmission unit is four (dotted square).

In FIG. 7, in the terminal device 100, a measurement timing of MG20 (SSB transmission G20) occurs during the survival time state. Therefore, the terminal device 100 shifts a performance timing of the MG20 (S21), and performs the MG at a timing of MG21. The timing of the MG21 is a timing of SSB transmission G21 within the same SMTC window period as the MG20 before the shift. In this manner, the terminal device 100 shifts the MG performance timing to, for example, the SSB transmission timing within the same SMTC window period.

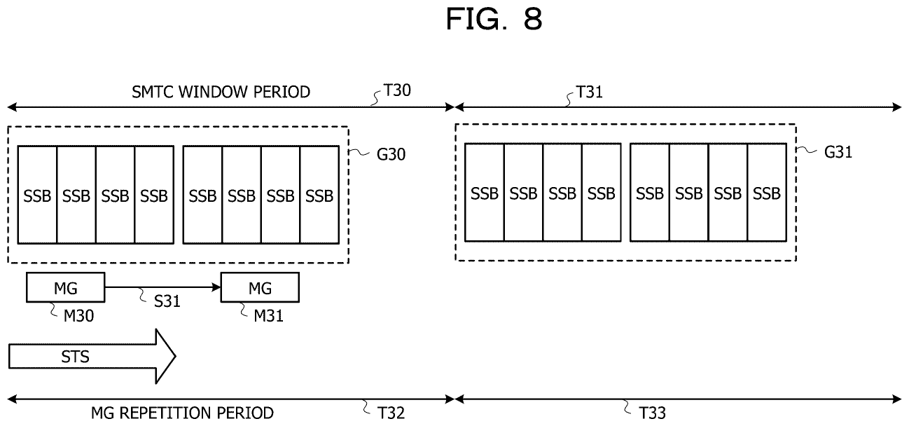

FIG. 8 is a diagram illustrating an example of the MG control. In FIG. 8, a period T30 and a period T31 indicate the SMTC window periods. Furthermore, in FIG. 8, a period T32 and a period T33 indicate MG performance cycles. Furthermore, the SSB transmission unit is eight.

In FIG. 8, in the terminal device 100, a measurement timing of MG30 (SSB transmission G30) occurs during the survival time state. Therefore, the terminal device 100 shifts a performance timing of the MG30 (S31), and performs the MG at a timing of MG31. The timing of the MG31 is a latter half of the timing of the SSB transmission G30 same as the MG30 before the shift. In this manner, the terminal device 100 shifts the MG performance timing to, for example, the latter half portion of the series of SSB transmission. Note that the latter half portion means behind the timing of the MG before the shift, and does not necessarily have to be a part behind the half of the series of SSB transmission. Furthermore, a condition of a shift destination of the MG may be that the survival time state has been ended (transition to a normal state has been performed).

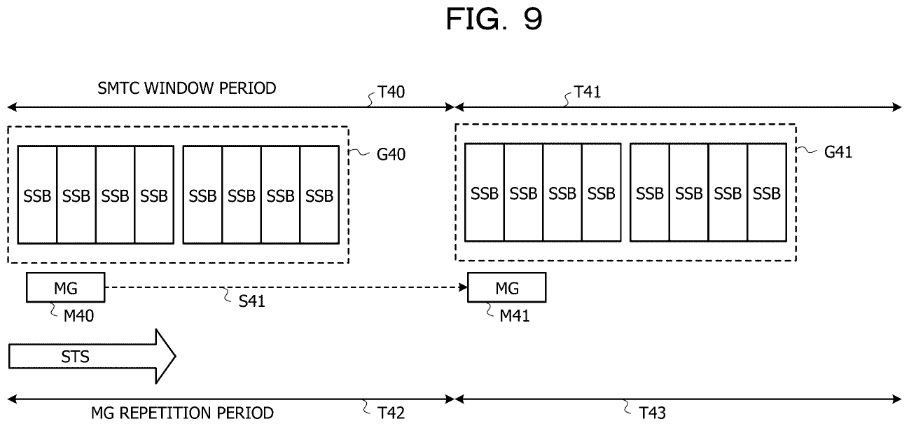

FIG. 9 is a diagram illustrating an example of the MG control. In FIG. 9, a period T40 and a period T41 indicate the SMTC window periods. Furthermore, in FIG. 9, a period T42 and a period T43 indicate the MG performance cycles. Furthermore, the SSB transmission unit is eight.

In FIG. 9, in the terminal device 100, a measurement timing of MG40 (SSB transmission G40) occurs during the survival time state. However, the survival time state in FIG. 9 continues longer than the survival time state in FIG. 8. Therefore, the terminal device 100 may not shift the MG40 in a latter half of the SSB transmission G40.

Therefore, the terminal device 100 cancels the MG40 and does not perform the MG until a performance timing of the next MG41 (S41). In this manner, for example, in a case where the survival time state continues for a long time and the MG performance timing may not be shifted to the latter half portion of the series of SSB transmission, the terminal device 100 cancels performance of the MG.

### <Generation of New Data in Survival Time State>

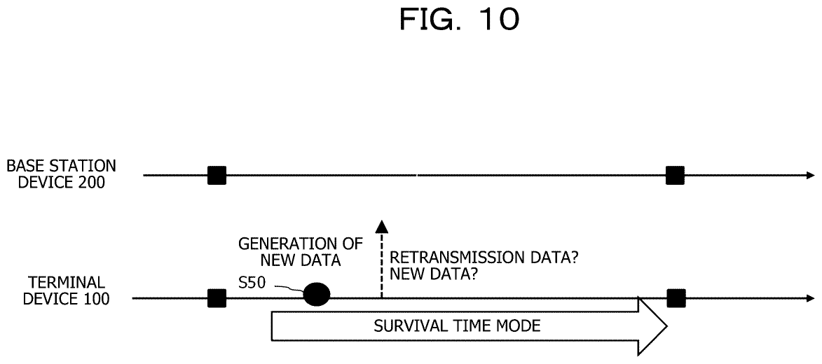

FIG. 10 is a diagram illustrating an example of generation of new data in the survival time state. For example, the terminal device 100 fails in data transmission and transitions to the survival time state. In the terminal device 100, new data that is not retransmission data is generated in the survival time state (S50). In the wireless communication system 10, which of the retransmission data and the new data is prioritized for transmission by the terminal device 100 in the survival time state is not determined.

In the terminal device 100, a radio resource control (RRC) signal, which may be data with higher transmission priority than IIoT data, may be generated. Examples of the RRC signal include the following.
Periodic report system: MeasurementReport/SRB1,3
Failure system: FailureInformation/SRB1,3, MCGFailureInformation/SRB1
Assistance information system: UEAssistanceInformation/SRB1,3
Control information system: ULInformationTransfer/SRB1,2, ULInformationTransferIRAT/SRB1, ULInformationTransferMRDC/SRB1,3

For example, in a case where data of the control information system is a control command of equipment in a factory, or the like, the data of the control information system may have a serious influence on the system when transmission may not be performed (is delayed). Therefore, the data of the control information system may have high priority.

Furthermore, there is a low possibility that data of the periodic report system immediately has a serious influence on the system even when transmission is delayed. Therefore, the data of the periodic report system may have low priority.

In this manner, the priority varies depending on content of the RRC signal. Therefore, it is needed to make it possible to determine superiority and inferiority between these pieces of data and the retransmission data.

For example, priority of a medium access control element (MAC CE) is configured higher than that of the retransmission data (UL data physical uplink shared channel (PUSCH)). Note that since a size of the MAC CE is relatively small, the base station device 200 may allocate wireless resources assuming the maximum size transmission.

Furthermore, for example, priority orders of the retransmission data and MG Report are configured to be the same (the same level). Since a size of the MG Report is relatively large, when the base station device 200 allocates wireless resources assuming the maximum size transmission, use efficiency of the wireless resources decreases, and thus the pre-allocation is not appropriate.

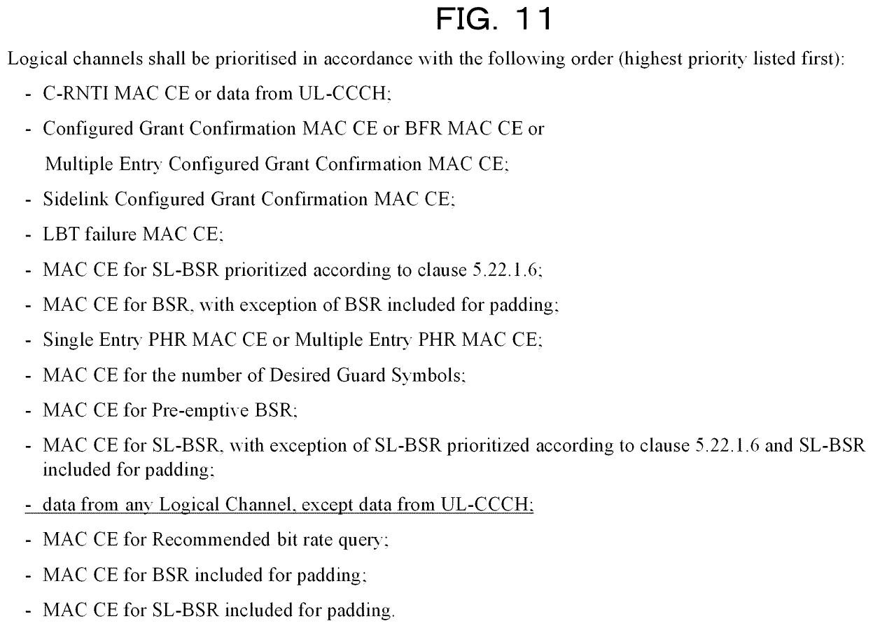

For example, Logical Channel Prioritization (LCP) described in TS38.321 which is a priority order standard is changed. FIG. 11 is a diagram illustrating an example of the Logical Channel Prioritization after the change. In FIG. 11, an underlined portion is an added specification. Note that an information element name and the like added in FIG. 11 are examples, and the present embodiment is not limited to these. Furthermore, in FIG. 11, an addition portion (row) of the information element is an example, and the present embodiment is not limited to this.

### OTHER EMBODIMENTS

The requirements described in the first, second, and other embodiments may be combined. Also, the requirements described in the first, second, and other embodiments may be used differently depending on, for example, the radio conditions, system requirements, or the like.

For example, when defined as 3GPP standardized specifications, the requirements described in the first, second, and other embodiments will be as follows.

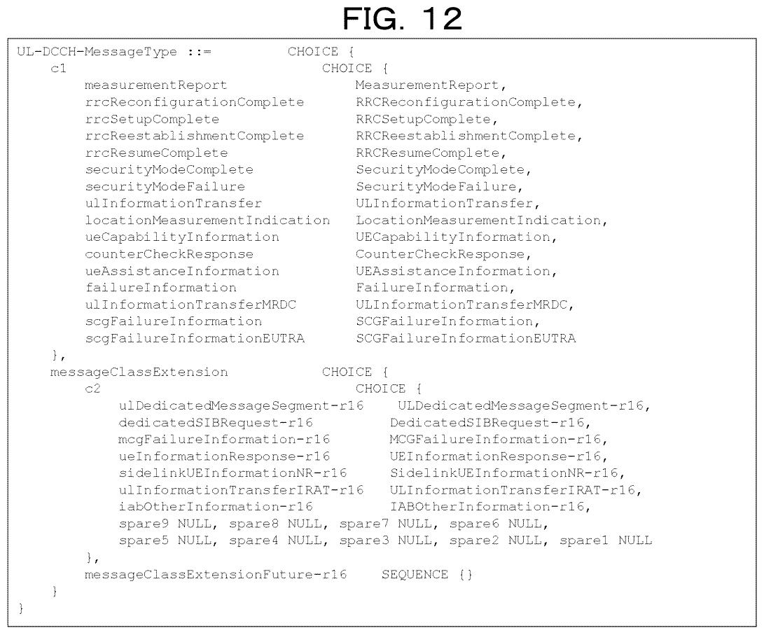

FIG. 12 is a diagram illustrating an example of an UL RRC message. This specification is described in, for example, TS38.331. In the wireless communication system 10, priority of physical uplink data channel (PUDCH) data (retransmission data or the like) in the survival time state is configured to be higher than that of messages illustrated in FIG. 12. The UL RRC message may have no transmission delay requirement. On the other hand, since the retransmission data has a requirement of the survival time, priority of the retransmission data is configured to be higher.

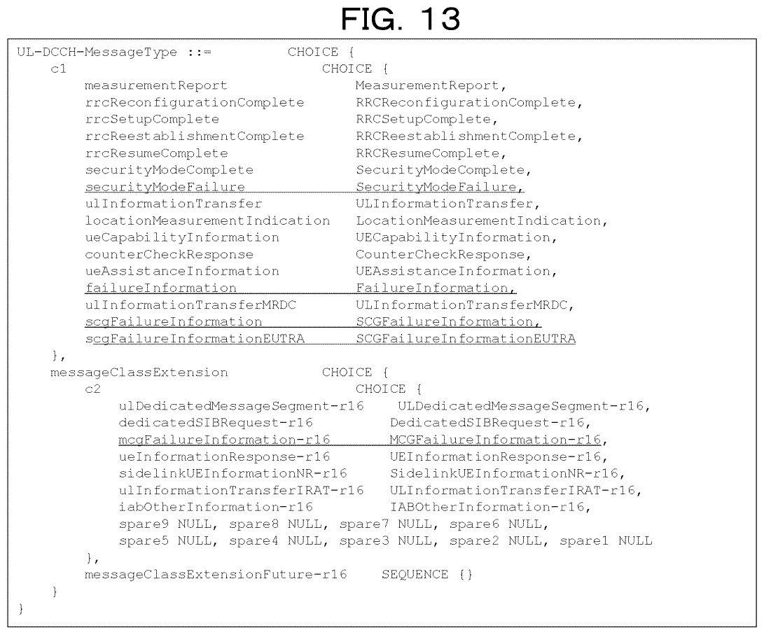

FIG. 13 is a diagram illustrating an example of the UL RRC message. This specification is described in, for example, TS38.331. In the wireless communication system 10, the priority of the PUDCH data (retransmission data or the like) in the survival time state is configured to be lower than that of any one of messages of underlined portions in FIG. 13. The underlined messages are control signals that notify occurrence of a certain problem (or that are transmitted when a problem occurs), and are preferably promptly notified to the base station device 200. Furthermore, the underlined messages may be configured higher, and the retransmission message may be configured lower than the underlined messages.

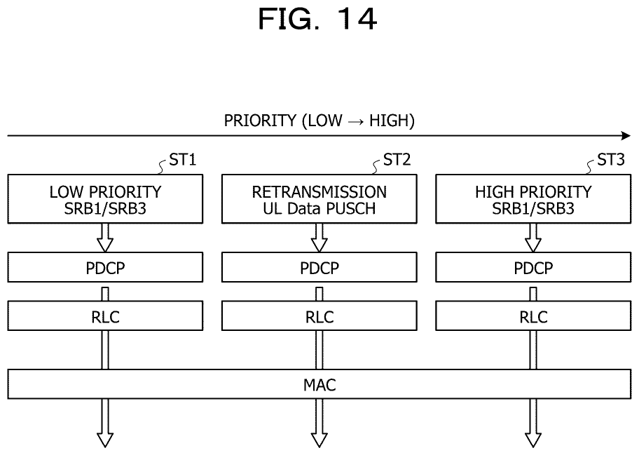

FIG. 14 is a diagram illustrating an example of Layer 2 architecture. The underlined messages in FIG. 13 use a stack ST3. Other RRC messages use a stack ST1. Additionally, the retransmission data (UL data PUSCH) uses a stack ST2. When the RRC message is generated, a scheduling request is generated, and the terminal device 100 compares priority with the retransmission UL data PUSCH, and transmits the one with the higher priority. As the priority, for example, a parameter referred to as LCH priority may be utilized. For example, as configuration of the priority of the retransmission data in the survival time state, there is a possibility that logical channel (LCH) priority (priority) of the data to be retransmitted is changed.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. A first wireless communication device in a wireless communication system, comprising:
a memory; and
processor circuitry coupled to the memory, the processor circuitry being configured to control communication with a second wireless communication device that has a survival time, being capable of controlling wireless measurement performed by the second wireless communication device in the survival time duration by using information related to performance of wireless measurement included in a control signal, and being capable of receiving data transmitted under priority control performed between the data and other data from the second wireless communication device.

2. The first wireless communication device according to claim 1, wherein
the information related to performance of the wireless measurement includes cancellation of the wireless measurement.

3. The first wireless communication device according to claim 1, wherein
the information related to performance of the wireless measurement includes a shift of a timing of the wireless measurement to a rear part of a time axis.

4. The first wireless communication device according to claim 3, wherein
a timing of the shift is a timing at a rear part of a time axis within a synchronization signal block (SSB)-based measurement timing configuration (SMTC) window that includes a performance timing of the wireless measurement before the shift.

5. The first wireless communication device according to claim 3, wherein
the timing of the shift is a timing at a rear part of a time axis in a series of SSB transmission that includes a performance timing of the wireless measurement before the shift.

6. The first wireless communication device according to claim 5, wherein
a controller cancels the wireless measurement in a case where the survival time duration does not end at the timing at the rear part of the time axis in the SSB transmission.

7. The first wireless communication device according to claim 1, wherein
data transmission is boosted in the survival time.

8. A second wireless communication device in a wireless communication system, comprising:
a second memory; and
second processor circuitry coupled to the second memory, the second processor circuitry being configured to have a survival time, performs wireless measurement according to information related to performance of wireless measurement included in a control signal in a survival time duration, and being capable of transmitting data according to priority control between the data and other data.
